(19) United States
(12) Patent Application Publication
(10) Pub. No.: US 2022/0206671 A1
(43) Pub. Date: Jun. 30, 2022

(54) AGENT DISPLAY METHOD, NON-TRANSITORY COMPUTER READABLE MEDIUM, AND AGENT DISPLAY SYSTEM

(71) Applicant: TOYOTA JIDOSHA KABUSHIKI KAISHA, Toyota-shi Aichi-ken (JP)

(72) Inventors: Ryosuke Nakanishi, Nisshin-shi Aichi-ken (JP); Hikaru Sugata, Miyoshi-shi Aichi-ken (JP)

(21) Appl. No.: 17/556,280

(22) Filed: Dec. 20, 2021

(30) Foreign Application Priority Data
Dec. 25, 2020 (JP) 2020-216964

(51) Int. Cl. G06F 3/04817; G06F 3/04812; G06F 16/332; G06F 16/31; H04L 51/02

(52) U.S. Cl. CPC G06F 3/04817; G06F 3/04812; H04L 51/02; G06F 16/313; G06F 16/3329

(57) ABSTRACT

The present disclosure provides an agent display method and the like that enable a user to easily determine an answer of an agent that should be referenced (checked) first among a plurality of agents. An agent display method for simultaneously displaying a plurality of agents each configured to respond to a speech text of a user, the agent display method including: an answer selection step of selecting the answer text of each of the plurality of agents to the speech text of the user; and an agent display step of displaying a screen including the plurality of agents, in which the agent display step includes changing, in accordance with an index indicating certainty of the answer text of at least one of the agents, a display form of the at least one of the agents.

### CROSS REFERENCE TO RELATED APPLICATIONS

This application is based upon and claims the benefit of priority from Japanese patent application No. 2020-216964, filed on Dec. 25, 2020, the disclosure of which is incorporated herein in its entirety by reference.

### BACKGROUND

The present disclosure relates to an agent display method, a non-transitory computer readable medium, and an agent display system, and, in particular, to an agent display method, a non-transitory computer readable medium, and an agent display system that enable a user to easily determine an answer of an agent that should be referenced (checked) first among a plurality of agents.

A Frequently Asked Questions (FAQ) chat bot system has been introduced for the purpose of improving the efficiency of responses to inquiries. A chatbot (hereinafter referred to as an agent) is a system that retrieves an answer to a user's question from a database (DB) of an FAQ using certain logic and displays the retrieved answer.

For example, Japanese Unexamined Patent Application Publication No. 2020-34626 discloses an agent management method for displaying, as an agent responding to a user speech text (utterance sentence), an agent (an agent including a user assumed text having a degree of similarity of a predetermined threshold or higher and the highest threshold) that satisfies a predetermined condition among a plurality of agents.

### SUMMARY

In the agent management method disclosed in Japanese Unexamined Patent Application Publication No. 2020-34626, it is possible to check an answer of each of the plurality of agents that respond to the user speech text by simultaneously displaying the plurality of agents (including the respective answers thereof). However, there is a problem that it is difficult for the user to determine an answer of an agent that should be referenced (checked) first among a plurality of agents.

The present disclosure has been made in order to solve such a problem, and provides an agent display method, a non-transitory computer readable medium, and an agent display system that enable a user to easily determine an answer of an agent that should be referenced (checked) first among a plurality of agents.

A first exemplary aspect is an agent display method for simultaneously displaying a plurality of agents each configured to respond to a speech text of a user, the agent display method including: a speech text acquisition step of acquiring the speech text of the user; an answer selection step of selecting, from a database of each of the agents storing a question text and an answer text corresponding to the question text, the answer text of each of the plurality of agents to the speech text of the user; and an agent display step of displaying a screen including the plurality of agents, in which the agent display step includes changing, in accordance with an index indicating certainty of the answer text of at least one of the agents, a display form of the at least one of the agents.

This configuration enables a user to easily determine an answer of an agent that should be referenced (checked) first among a plurality of agents.

This is because, since a display form of an agent is changed in accordance with an index indicating certainty of the answer text of the agent (for example, the number of characters displayed in the answer text increases and the size of the agent image to be displayed increases as the index indicating the certainty of the answer text increases), that is, since the agent to be referenced to (checked) is emphasized, it is possible for a user to easily know an answer of an agent that should be referenced (checked) first among a plurality of agents.

Note that the agent display step may include changing the display form of the answer text of the agent in accordance with the index.

Further, the display form of the answer text to be changed may be the number of characters displayed in the answer text.

Further, the agent display step may include changing the display form of an agent image symbolizing the agent in accordance with the index.

Further, the display form of the agent image to be changed may be a size of the agent image.

Further, the display form of the agent image to be changed may be a facial expression of the agent.

Further, the display form of the agent image to be changed may be a density of the agent image.

Further, the display form of the agent image to be changed may be an additional display that is additionally displayed near the agent image.

Further, the answer selection step may include selecting the answer texts of the plurality of respective agents to the speech text of the user from the database based on a degree of similarity between the speech text of the user and the question text stored in the database.

Further, the answer selection step may include selecting the answer texts of the plurality of respective agents to the speech text of the user from the database based on the degree of similarity between the speech text of the user and the question text stored in the database and a feature of the agent.

Further, the answer text of each of the plurality of agents to the speech text of the user may be an overview of the answer text.

Further, the agent display method may further include: a selection receiving step of receiving the selection performed by the user with regard to the agents; and a step of displaying a detail of the answer text of the agent selected by the user from among the agents.

Another exemplary aspect is a non-transitory computer readable medium storing a program for causing an information processing apparatus including at least one processor to execute: speech text acquisition processing of acquiring a speech text of a user; answer selection processing of selecting, from a database of each of a plurality of agents storing a question text and an answer text corresponding to the question text, the answer text of each of the plurality of agents to the speech text of the user; and agent display processing of displaying a screen including the plurality of agents, in which the agent display processing includes changing, in accordance with an index indicating certainty of the answer text of at least one of the agents, a display form of the at least one of the agents.

Another exemplary aspect is an agent display system configured to simultaneously display a plurality of agents each configured to respond to a speech text of a user, the agent display system including: a speech text acquisition unit configured to acquire the speech text of the user; an answer selection unit configured to select, from a database of each of the agents storing a question text and an answer text corresponding to the question text, the answer text of each of the plurality of agents to the speech text of the user; and an agent display unit configured to display a screen including the plurality of agents, in which the agent display unit changes, in accordance with an index indicating certainty of the answer text of at least one of the agents, a display form of the at least one of the agents.

According to the present disclosure, it is possible to provide a an agent display method, a non-transitory computer readable medium, and an agent display system that enable a user to easily determine an answer of an agent that should be referenced (checked) first among a plurality of agents.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic configuration diagram of an agent display system 1;

FIG. 2 shows an example of information (agent information) about each of a plurality of agents stored in an agent information storage unit 11b;

FIG. 3 is a sequence diagram of an operation example of the agent display system 1;

FIG. 4 is a sequence diagram of an operation example of the agent display system 1;

FIG. 5 is a flowchart of an operation example (a user speech analysis) of a user speech analysis unit 12b;

FIG. 6 is a flowchart of an operation example (a change of a display form) of a display content determination unit 12d;

FIG. 7A is a graph showing a relation between a highest score (x) and the number of displayed characters f(x);

FIG. 7B is a graph showing a relation between a highest score (x) and the number of displayed characters f(x);

FIG. 7C is a graph showing a relation between a highest score (x) and the number of displayed characters f(x);

FIG. 8 is an example of a screen displayed on a display unit 26;

FIG. 9 is an example of a screen displayed on the display unit 26; and

FIG. 10 is an example of a screen (a modified example) displayed on the display unit 26.

### DESCRIPTION OF EMBODIMENTS

An agent display system 1 according to an embodiment of the present disclosure will be described hereinafter with reference to the accompanying drawings. The same components are denoted by the same reference signs throughout the drawings, and redundant descriptions will be omitted.

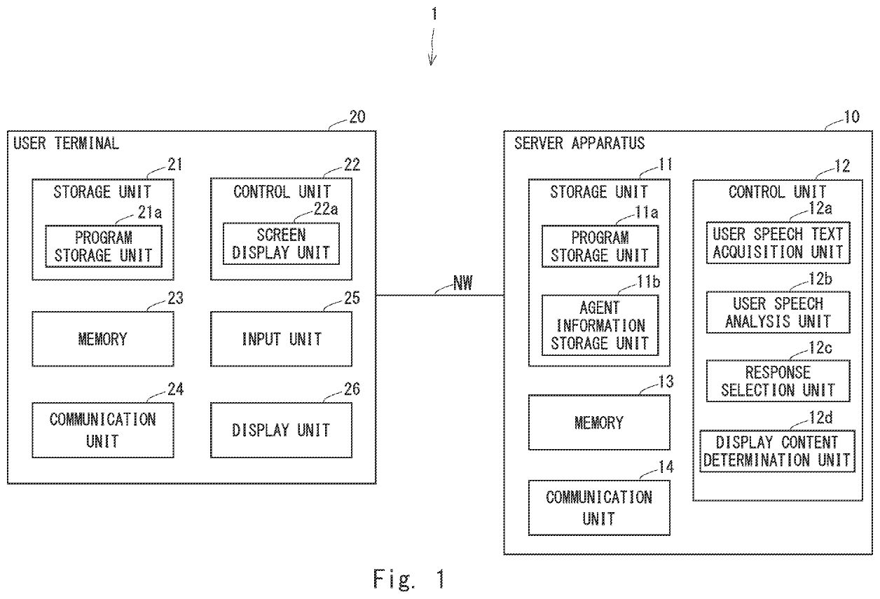

FIG. 1 is a schematic configuration diagram of the agent display system 1.

First, an outline of the agent display system 1 will be described.

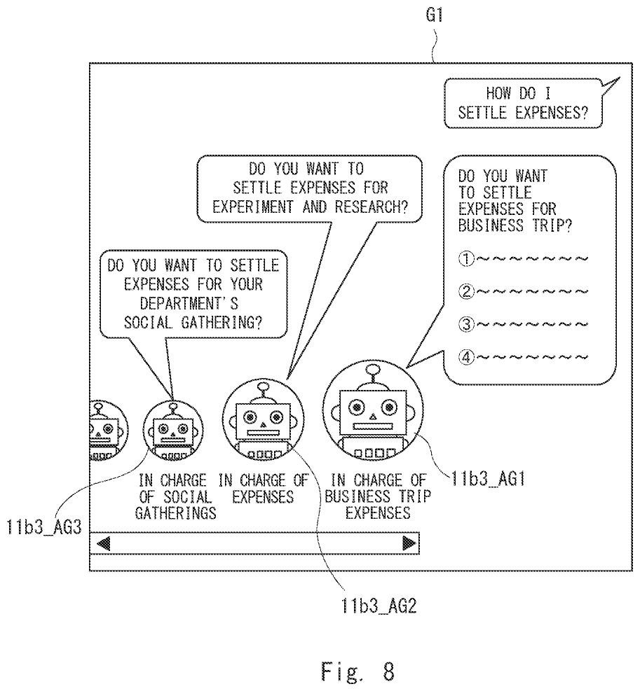

The agent display system 1 is a system that simultaneously displays a plurality of agents responding to a speech text (utterance sentence) of a user. In the agent display system 1, a screen (see, for example, a screen G1 shown in FIG. 8) including an agent image symbolizing each of the plurality of agents, an answer (e.g., an overview) of each of the plurality of agents to the speech text of the user, and the like is displayed. At this time, a display form of at least one agent among the plurality of agents (e.g., the number of characters displayed in the answer text of the at least one agent and the size of an agent image symbolizing the at least one agent) is changed in accordance with an index (a degree of certainty or a degree of confidence) indicating the certainty of the answer text of the agent. The index indicating the certainty of the answer text is, for example, a score of the answer text of each of the plurality of agents selected by a response selection unit 12c which will be described later.

For example, regarding an agent of which the index indicating the certainty of the answer text is large, the number of characters displayed in the answer text is increased and the size of the agent image is increased, like those of the agent (e.g., an agent image 11b3_AG1) shown in FIG. 8. On the other hand, regarding other agents (e.g., agent images 11b3_AG2 and 11b3_AG3), the number of characters displayed in the answer text is reduced and the size of the agent image is reduced. When one of the plurality of agents (the agent images) is selected by the user (e.g., the user hovers the mouse over it), the answer (e.g., the detail) of the selected agent is displayed.

Next, the agent display system 1 will be described in detail.

As shown in FIG. 1, the agent display system 1 includes a server apparatus 10 and a user terminal 20. The server apparatus 10 and the user terminal 20 are connected to each other via a network NW (e.g., the Internet), and can communicate with each other via the network NW.

### <Configuration Example of the Server Apparatus 10>

First, a configuration example of the server apparatus 10 will be described.

The server apparatus 10 is, for example, an information processing apparatus such as a personal computer. The server apparatus may be a physical server or a virtual server on the network NW. The server apparatus 10 includes a storage unit 11, a control unit 12, a memory 13, and a communication unit 14.

The storage unit 11 is, for example, a nonvolatile storage unit such as a hard disk device or a Read Only Memory (ROM). The storage unit 11 includes a program storage unit 11a and an agent information storage unit 11b.

The program storage unit 11a stores programs to be executed by the control unit 12 (a processor).

The agent information storage unit 11b stores information (agent information) about each of a plurality of agents.

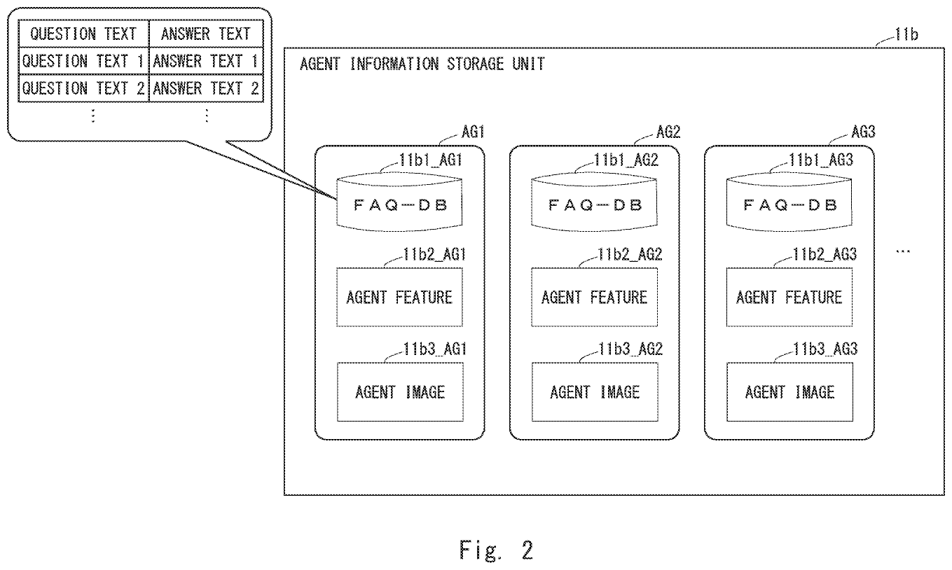

FIG. 2 shows an example of the information (the agent information) about each of the plurality of agents stored in the agent information storage unit 11b. In FIG. 2, information (agent information) about three respective agents AG1 to AG3 is shown.

As shown in FIG. 2, the agent information about the agent AG1 includes an FAQ-DB 11b1_AG1, an agent feature 11b2_AG1, and the agent image 11b3_AG1. The agent information about the agents AG2 and AG3 includes FAQ-DBs, agent features, and agent images similar to those included in the information about the agent AG1. Note that the agent features 11b2_AG1 to 11b2_AG3 may be omitted. In the following description, when the FAQ-DBs 11b1_AG1 to 11b1_AG3 are not particularly distinguished from each other, the FAQ-DBs 11b1_AG1 to 11b1_AG3 will be respectively referred to as the FAQ-DB 11b1. Further, when the agent features 11b2_AG1 to 11b2_AG3 are not particularly distinguished from each other, the agent features 11b2_AG1 to 11b2_AG3 will be respectively referred to as the agent feature 11b2. Further, when the agent images 11b3_AG1 to 11b3_AG3 are not particularly distinguished from each other, the agent images 11b3_AG1 to 11b3_AG3 will be respectively referred to as the agent image 11b3.

The FAQ-DB 11b1 stores “question texts” and “answer texts” as items. Note that although not shown in the figure, the FAQ-DB 11b1 may store “overviews” as an item in addition to the “question texts” and the “answer texts”.

For example, question texts (e.g., text data) and text vectors thereof are stored in the “question texts”. Answer texts (e.g., text data) corresponding to the “question texts” are stored in the “answer texts”. Overviews (summaries) of the “answer texts” are stored in the “overviews”. The “overviews” may be created manually (by a person) in advance or generated dynamically by a machine. When a machine dynamically generates the “overviews”, for example, it may generate, by using a machine learning method such as seq2seq DNN, the “overviews” each time using the “question texts” stored in the FAQ-DB 11b1 as inputs.

The agent feature 11b2 is, for example, a feature word representing a feature of the agent. The feature of the agent may be defined manually in advance, or may be created mechanically from the FAQ-DB 11b1 (the answer texts stored in the “answer texts”) by using a method such as Term Frequency-Inverse Document Frequency (tf-idf).

The control unit 12 includes the processor (not shown). The processor is, for example, a Central Processing Unit (CPU). The control unit 12 may include one or a plurality of processors. The processor executes a program loaded from the storage unit 11 (the program storage unit 11a) into the memory 13 (e.g., Random Access Memory (RAM)), thereby functioning as a user speech text acquisition unit 12a, a user speech analysis unit 12b, a response selection unit 12c, and a display content determination unit 12d. Some or all of these units may be implemented by hardware.

The user speech text acquisition unit 12a acquires a speech text (text data) of a user input from an input unit 25 of the user terminal 20.

The user speech analysis unit 12b analyzes the speech text (the text data) of the user acquired by the user speech text acquisition unit 12a, and performs scoring for answering. An operation example of the user speech analysis unit 12b will be described later.

The response selection unit 12c selects answer texts of a plurality of respective agents to the speech text of the user acquired by the user speech text acquisition unit 12a from the databases (the FAQ-DBs 11b1_AG1 to 11b1_AG3) for each agent storing a question text and an answer text corresponding to the question text. Specifically, the response selection unit 12c selects, from the databases (the FAQ-DBs 11b1_AG1 to 11b1_AG3), answer texts of the plurality of respective agents to the speech text of the user based on the degree of similarity (score) between the speech text of the user acquired by the user speech text acquisition unit 12a and the question text stored in the databases (the FAQ-DBs 11b1_AG1 to 11b1_AG3). An operation example of the response selection unit 12c will be described later.

The display content determination unit 12d changes a display form (e.g., the number of characters displayed in the answer text and the size of the agent image. Hereinafter also referred to as a display format.) of the agent in accordance with an index indicating the certainty of the answer text of the agent. The index indicating the certainty of the answer text is, for example, a score of the answer text of each of the plurality of agents selected by the response selection unit 12c. An operation example of the display content determination unit 12d will be described later.

The communication unit 14 is a communication apparatus which communicates with the user terminal 20 via the network NW (e.g., the Internet). For example, the communication unit 14 receives a speech text of a user transmitted from the user terminal 20. Further, the communication unit 14 transmits screen display data for displaying a screen (see, for example, the screen G1 shown in FIG. 8) including a plurality of agents to the user terminal 20. The screen display data includes displays showing the answer texts of the plurality of respective agents selected by the response selection unit 12c, agent images symbolizing the plurality of respective agents, and organizations to which the plurality of respective agents belong.

### <Configuration Example of the User Terminal 20>

Next, a configuration example of the user terminal 20 will be described.

The user terminal 20 is, for example, an information processing apparatus such as a personal computer. As shown in FIG. 1, the user terminal 20 includes a storage unit 21, a control unit 22, a memory 23, a communication unit 24, the input unit 25, and a display unit 26.

The storage unit 21 is, for example, a nonvolatile storage unit such as a hard disk device or a Read Only Memory (ROM). The storage unit 21 includes a program storage unit 21a.

The program storage unit 21a stores programs to be executed by the control unit 22 (a processor).

The control unit 22 includes the processor (not shown). The processor is, for example, a Central Processing Unit (CPU). The control unit 22 may include one or a plurality of processors. The processor executes a program loaded from the storage unit 21 (the program storage unit 21a) into the memory 23 (e.g., Random Access Memory (RAM)), thereby functioning as a screen display unit 22a. This unit may be implemented by hardware.

When the communication unit 24 receives screen display data transmitted from the server apparatus 10, the screen display unit 22a displays a screen (see, for example, the screen G1 shown in FIG. 8) including a plurality of agents on the display unit 26 based on the received screen display data. At this time, the screen display unit 22a changes a display form (e.g., the number of characters displayed in the answer text and the size of the agent image) of at least one agent in accordance with an index indicating the certainty of the answer text of the agent. An operation example of the screen display unit 22a will be described later.

The communication unit 24 is a communication apparatus which communicates with the server apparatus 10 via the network NW (e.g., the Internet). For example, the communication unit 24 receives screen display data transmitted from the server apparatus 10. Further, the communication unit 24 transmits a speech text of a user input from the input unit 25 to the server apparatus 10.

The input unit 25 is an input unit that inputs a speech text of a user. The input unit 25 is, for example, an input device such as a keyboard or a mouse. The input unit 25 may be a microphone. When the input unit 25 is a microphone, an input speech text of a user is converted into text data by voice recognition processing.

The display unit 26 is, for example, a display device such as a liquid crystal display.

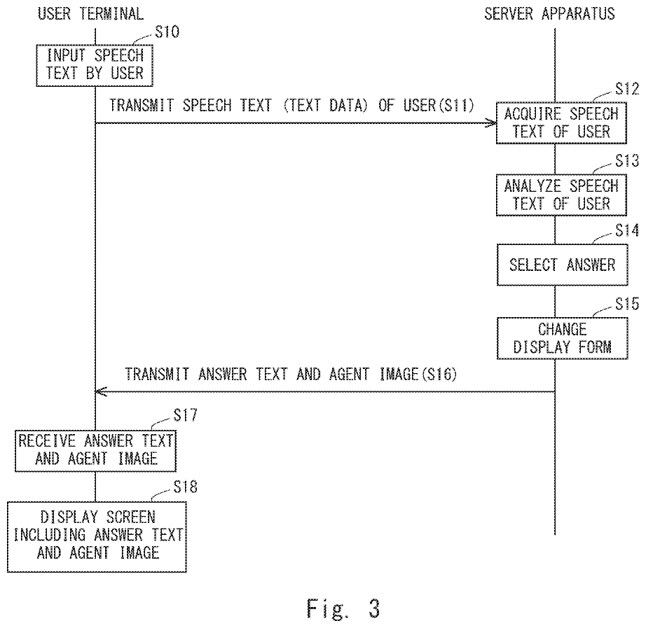

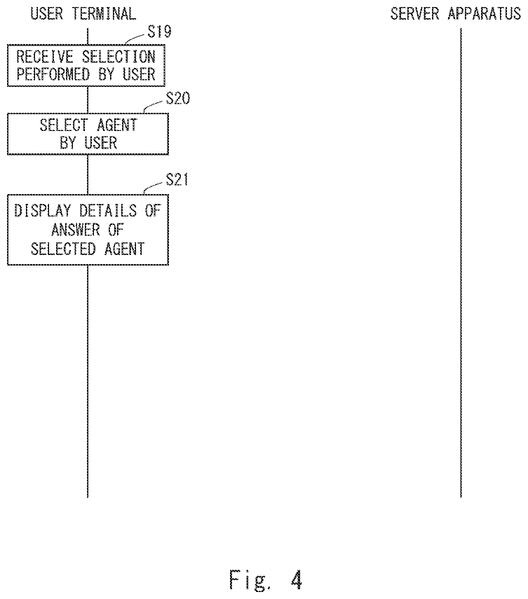

Next, an operation example of the agent display system 1 will be described with reference to FIGS. 3 and 4. FIGS. 3 and 4 are each sequence diagrams of the operation examples of the agent display system 1. In the following description, as shown in FIG. 2, an example in which three agents AG1 to AG3 are stored in the storage unit 11 (the agent information storage unit 11b) will be described.

First, a user inputs a speech text through the input unit 25 of the user terminal 20 (Step S10). Here, it is assumed that “How do I settle expenses?” (text data) is input as the speech text of the user.

Next, the user terminal 20 (the communication unit 24) transmits the speech text of the user input in Step S10 to the server apparatus 10 (Step S11).

Next, the server apparatus 10 (the user speech text acquisition unit 12a) acquires the speech text of the user transmitted from the user terminal 20 (Step S12).

Next, the server apparatus 10 (the user speech analysis unit 12b) executes a user speech analysis (Step S13).

The operation example (the user speech analysis) of the user speech analysis unit 12b will be described below.

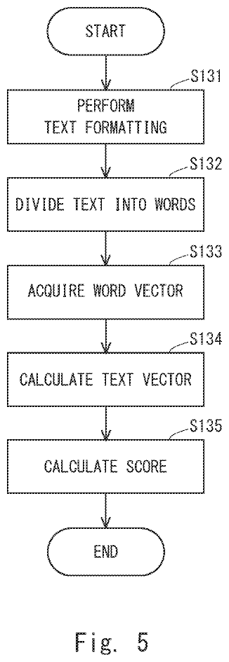

FIG. 5 is a flowchart of the operation example (the user speech analysis) of the user speech analysis unit 12b.

First, the user speech analysis unit 12b performs text formatting on the speech text (text data that is raw data) of the user acquired in Step S12 (Step S131). The text formatting includes, for example, processing for unifying full-width/half-width characters and processing for performing replacement of a specific word.

Next, the user speech analysis unit 12b divides the speech text of the user on which the text formatting has been performed in Step S131 into words (Step S132), and acquires a word vector of each word by referring to a word vector dictionary (not shown) (Step S133). Although not shown in the figure, the word vector dictionary represents the meaning of each word by a vector, and is, for example, stored in the storage unit 11.

Next, the user speech analysis unit 12b calculates a text vector from the word vector acquired in Step S133 (Step S134). The text vector represents a whole text as a vector. The text vector may be calculated, for example, by averaging the elements of the word vectors, or may be calculated using a Deep Neural Network (DNN) such as a Long Short-Term Memory (LSTM).

Next, the user speech analysis unit 12b calculates a score between the text vector (the text vector of the speech text of the user) calculated in Step S134 and the text vector of each question text stored in the FAQ-DB 11b1 (Step S135). The score is an index (a numerical value) indicating a degree of similarity between the speech text of the user and each question text stored in the FAQ-DB 11b1. In the following description, the score may be referred to as a degree of similarity. The score may be calculated, for example, by calculating a distance between the vectors by a cosine distance or by using a classification model of machine learning (such as a Support Vector Machine (SVM) and a Convolutional Neural Network (CNN)). In such a case, the agent feature 11b2 may be used.

The processing of Step S135 is executed for each agent. For example, for the agent AG1, the score between the speech text of the user (in this case, the text vector of “How do I settle expenses?”) and the text vector of each question text stored in the FAQ-DB 11b1_AG1 (see FIG. 2) of the agent AG1 is calculated. For the agents AG2 and AG3, the score is calculated in a manner similar to that in the case of the agent AG1.

Referring back to FIG. 3, the description of the operation example of the agent display system 1 will be continued.

Next, the server apparatus 10 (the response selection unit 12c) selects, from the databases (the FAQ-DBs 11b1_AG1 to 11b1_AG3), answer texts of the plurality of respective agents to the speech text of the user based on the degree of similarity (score) between the speech text of the user acquired by the user speech text acquisition unit 12a and the question text stored in the databases (the FAQ-DBs 11b1_AG1 to 11b1_AG3) (Step S14). For example, for the agent AG1, the response selection unit 12c selects, from the FAQ-DB 11b1_AG1, an answer text (an answer text having the highest score) to the speech text of the user based on a degree of similarity between the speech text of the user and each question text stored in the FAQ-DB 11b1_AG1. For the agents AG2 and AG3, the response selection unit 12c selects answer texts in a manner similar to that in the case of the agent AG1.

Here, it is assumed that, for the agent AG1, “Do you want to settle the expenses for the business trip? . . . ” (the score: 0.8) is selected from the FAQ-DB 11b1_AG1 as the answer text (the overview) having the highest score for the speech text of the user. Further, it is assumed that, for the agent AG2, “Do you want to settle the expenses for the experiment and research?” (the score: 0.7) is selected from the FAQ-DB 11b1_AG2 as the answer text (the overview) having the highest score for the speech text of the user. Further, it is assumed that, for the agent AG3, “Do you want to settle the expenses for your department's social gathering?” (the score: 0.6) is selected from the FAQ-DB 11b1_AG3 as the answer text (the overview) having the highest score for the speech text of the user.

Further, the server apparatus 10 (the response selection unit 12c) rearranges the agents and the answers in a descending order based on the maximum score that each agent has.

Next, the server apparatus 10 (the display content determination unit 12d) changes a display form of an agent in accordance with an index indicating the certainty of the answer text of the agent (Step S15).

There are two possible methods for changing the display form of the agent.

A first method for changing the display form is a method using an absolute value of the highest score of each agent. The first method for changing the display form is used when it is desired to uniformly evaluate all QAs (questions and answers to the questions).

The second method for changing the display form is a method using a relative value (ratio) of the highest score of all the agents and the highest score of each agent. The second method uses the relative value (ratio) of the highest score of all the agents and the highest score of each agent. The second method for changing the display form is used when it is not desired to evaluate all the QAs (questions and answers to the questions) by the same criterion (when it is desired to emphasize the degree of certainty between the agents). Note that, in the second method for changing the display form, when the highest score itself is small, the ratio becomes high even if the score of each agent is small. In this case, although a degree of importance as an absolute value is small, a degree of importance of the display may increase. Therefore, when the highest score of all the agents is small, a detailed display may be permitted for the agent having the highest score of all the agents, while a detailed display may not be permitted (the overview may always be displayed) for the other agents.

A description will be given below of an example in which the display form (the number of characters displayed in the answer) of the agent (the agent AG1 in this case) having the highest score of all the agents is changed and the display forms (the number of characters displayed in the answer) of other agents are not changed. Specifically, a description will be given of an example (e.g., an example in which the number of characters displayed in the answer text is increased as the index indicating the certainty of the answer text increases) in which the number of characters displayed in the answer text of the agent (the agent AG1 in this case) is changed to the number of characters corresponding to the index indicating the certainty of the answer text of the agent.

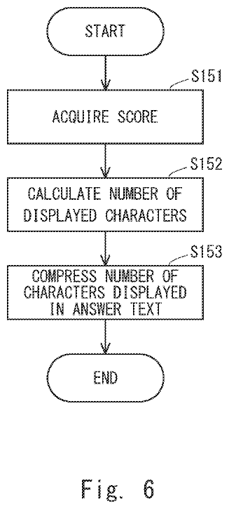

FIG. 6 is a flowchart of an operation example (a change of a display form) of the display content determination unit 12d.

First, the display content determination unit 12d acquires a score of the answer selected in Step S14 (an index indicating certainty of the answer text) (Step S151). It is assumed here that the score of the agent AG1 having the highest score of all the agents has been acquired.

Next, the display content determination unit 12d calculates the number of characters displayed in the answer text based on the score (the index indicating the certainty of the answer text) obtained in Step S151 (Step S152).

For example, the number of characters displayed in the answer text is calculated using the function shown in the following Expression 1. In Expression 1, x is the score (the highest score) acquired in Step S151 (in the case of the first method for changing the display form). When the distance between the vectors is calculated by the cosine distance, x is in the range of 0≤x≤1. Note that, in the case of the second method of changing the display form, x is the highest score of each agent/the highest score of all the agents.

f(x)=100x+10 [Expression 1]

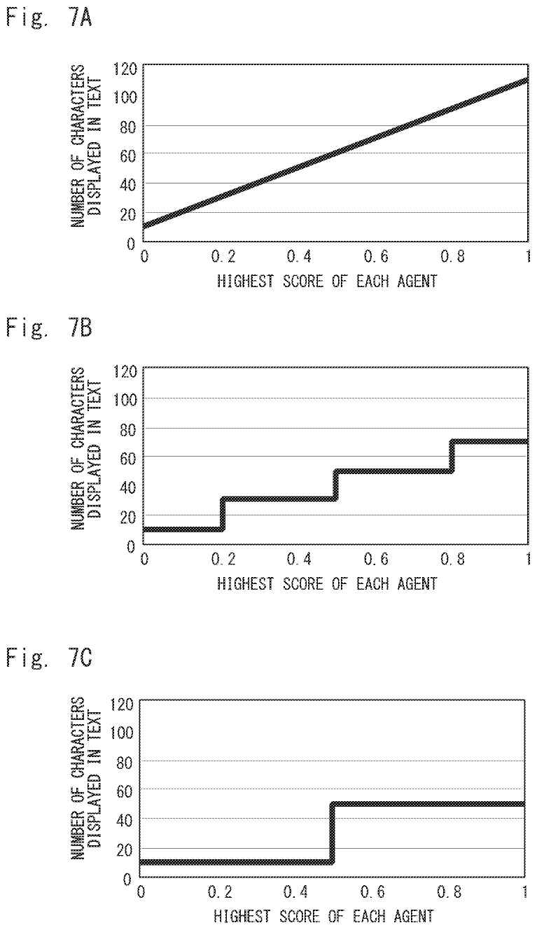

When this Expression 1 is used, the relation between the highest score (x) and the number of displayed characters f(x) is represented by a graph shown in FIG. 7A. FIG. 7A-7C is a graph showing a relation between the highest score (x) and the number of displayed characters f(x).

Note that the number of characters displayed in the answer text may be calculated using the function shown in the following Expression 2.

$$f ( x ) = \{ \begin{matrix}10 , & 0 \leq x < 0.2 \\ 30 , & 0.2 \leq x < 0.5 \\ 50 , & 0.5 \leq x < 0.8 \\ 70 , & otherwise\end{matrix} \qquad [ Expression 2 ]$$

When this Expression 2 is used, the relation between the highest score (x) and the number of displayed characters f(x) is represented by a graph shown in FIG. 7B.

Note that the number of characters displayed in the answer text may be calculated using the function shown in the following Expression 3.

$$f ( x ) = \{ \begin{matrix}10 , & 0 \leq x < 0.5 \\ 50 , & otherwise\end{matrix} \qquad [ Expression 3 ]$$

When this Expression 3 is used, the relation between the highest score (x) and the number of displayed characters f(x) is represented by a graph shown in FIG. 7C.

Next, the display content determination unit 12d compresses the number of characters displayed in the answer text so that it becomes the number of displayed characters calculated in Step S152 (Step S153).

There are three possible methods for the compression.

A first method is a method for compressing the number of characters displayed in the answer text so that the number of characters from the beginning of the text to the number of displayed characters calculated in Step S152 is displayed. The characters after the number of displayed characters calculated in Step S152 from the beginning of the text are omitted by “ . . . ” or the like.

A second method is a method for compressing the number of characters displayed in the answer text so that it becomes the number of displayed characters calculated in Step S152 by manually preparing an answer text in advance for each number of characters specified by the above function, storing it in the storage unit such as the FAQ-DB 11b1, and then acquiring the answer text having the corresponding number of characters from the FAQ-DB 11b1.

A third method is a method for compressing the number of characters displayed in the answer text so that it becomes the number of displayed characters calculated in Step S152 by generating an “overview (summary text)” each time using a machine learning model such as seq2seq DNN with the answer text of the FAQ-DB created by a person and the number of displayed characters (the maximum number of characters) calculated in Step S152 as inputs.

Note that when the display form (e.g., the number of characters displayed in the answer text) of the agent is changed in accordance with an index indicating the certainty of the answer text of the agent by using the above Expressions 1 to 3, the numbers of characters displayed in the answer texts of the respective agents are respectively controlled. Thus, when the highest score of each agent is large, the numbers of characters displayed in the answer texts of a plurality of agents increase, and as a result, a display area may be compressed.

Therefore, the detailed display may be permitted for the agent having the highest score among the plurality of agents, while the detailed display may not be permitted (the overview may always be displayed) for the other agents.

Alternatively, the detailed display may be permitted for the agent having the highest score and two or three agents having the higher scores among the plurality of agents, while the detailed display may not be permitted (the overview may always be displayed) for the other agents.

Note that, by using a function (a function similar to the above Expressions 1 to 3) in which the vertical axis of each of the respective graphs shown in FIGS. 7A to 7C has been changed to that of the magnification of the agent image, it is possible to change the sizes of the agent images symbolizing the plurality of respective agents. Specifically, it is possible to increase the size of the agent image as the index indicating the certainty of the answer text increases.

Note that it is assumed that a distinction may be made between the display form of the answer of an agent which is most likely to be accurate (e.g., the above-described score is high) among the answers of a plurality of agents and the display forms of the answers of agents which are not likely to be accurate, and then the processing of Step S15 may be executed for the answer which is most likely to be accurate. By doing so, it is possible to present to a user an agent which it is desired that the user visually recognize first, and then to support the user in making a more detailed determination by dynamically updating the display of the presented agent.

Referring back to FIG. 3, the description of the operation example of the agent display system 1 will be continued.

Next, the server apparatus 10 (the communication unit 14) transmits screen display data for displaying a screen (see, for example, the screen G1 shown in FIG. 8) including a plurality of agents to the user terminal 20 (Step S16). The screen display data includes displays showing the answer texts (e.g., the answer text of the agent AG1 “Do you want to settle the expenses for the business trip? . . . ”, the answer text of the agent AG2 “Do you want to settle the expenses for the experiment and research?”, and the answer text of the agent AG3 “Do you want to settle the expenses for your department's social gathering?”) of the plurality of respective agents selected by the response selection unit 12c. Note that, in FIG. 8, as described above, the number of characters of the answer text of the agent AG1 has been changed by the display content determination unit 12d to the number of characters corresponding to the index indicating the certainty of the answer text.

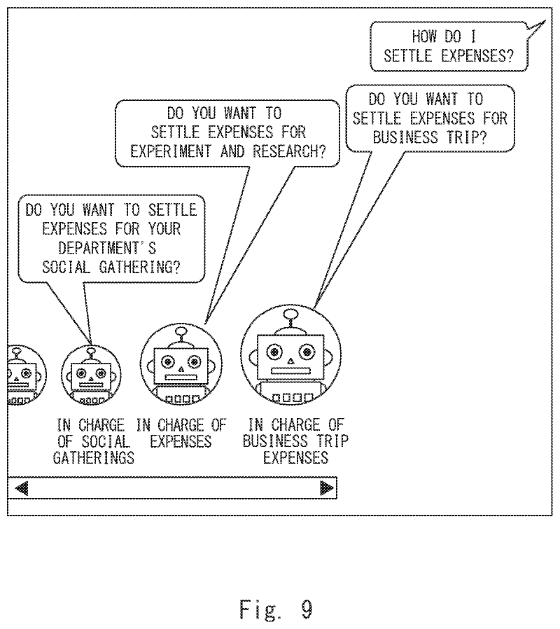

Note that when the number of characters of the answer text is larger than a threshold, “details” of the answer, like those of the answer of the agent 11b3_AG1 shown in FIG. 8, may be displayed, while when the number of characters of the answer text is smaller than the threshold, display characters, like those in the other agents as shown in FIG. 9, may be reduced.

Further, the aforementioned screen display data includes agent images symbolizing the plurality of respective agents (e.g., the agent images 11b3_AG1 to 11b3_AG3 symbolizing the plurality of respective agents AG1 to AG3). Each of the sizes of the agent images symbolizing the plurality of respective agents has been changed by the display content determination unit 12d to a size corresponding to the index indicating the certainty of the answer text of each of the plurality of agents. Specifically, the size of the agent image has increased as the index indicating the certainty of the answer text has increased. Further, the aforementioned screen display data includes organizations (e.g., “in charge of business trip expenses”, “in charge of expenses”, and “in charge of social gatherings”) to which the plurality of respective agents belong.

Next, the user terminal 20 (the communication unit 24) receives the screen display data transmitted from the server apparatus 10 (Step S17).

Next, the user terminal 20 (the screen display unit 22a) displays a screen (see, for example, the screen G1 shown in FIG. 8) including a plurality of agents on the display unit 26 based on the screen display data received in Step S17 (Step S18).

The screen including a plurality of agents includes displays showing the answer texts (e.g., the answer text of the agent AG1 “Do you want to settle the expenses for the business trip? . . . ”, the answer text of the agent AG2 “Do you want to settle the expenses for the experiment and research?”, and the answer text of the agent AG3 “Do you want to settle the expenses for your department's social gathering?”) of the plurality of respective agents selected by the response selection unit 12c, agent images symbolizing the plurality of respective agents (e.g., the agent images 11b3_AG1 to 11b3_AG3 symbolizing the plurality of respective agents AG1 to AG3), and organizations (e.g., “in charge of business trip expenses”, “in charge of expenses”, and “in charge of social gatherings”) to which the plurality of respective agents belong.

In Step S18, a large number of characters are displayed in the answer text of the agent AG1 of which the index indicating the certainty of the answer text is large. Further, the size of the agent image to be displayed increases as the index indicating the certainty of the answer text increases. FIG. 8 shows an example of a screen displayed on the display unit 26. In other words, the number of characters and the display size of the agent are changed in accordance with the magnitude of the score that each agent has. At this time, the respective agents are sorted in the order of scores. Each agent displays the overview of the answer in a simple display format. Note that it is conceivable to display the overview at various timings. For example, it may be always displayed, it may be displayed at the timing when a user hovers the mouse over the agent, or it may be displayed so as to blink at regular intervals.

Referring back to FIG. 4, the description of the operation example of the agent display system 1 will be continued.

Next, the user terminal 20 receives the selection performed by the user with regard to the plurality of agents (the agent images 11b3_AG1 to 11b3_AG3) displayed on the screen (Step S19).

Next, when one of the plurality of agents (the agent images 11b3_AG1 to 11b3_AG3) is selected by the user (e.g., the user hovers the mouse over it) (Step S20), the answer (e.g., the details) of the selected agent is displayed on the display unit 26 (Step S21).

As described above, according to this embodiment, it is possible for a user to easily determine an answer of an agent that should be referenced (checked) first among a plurality of agents.

This is because, since a display form of an agent is changed in accordance with an index indicating certainty of the answer text of the agent (for example, the number of characters displayed in the answer text increases and the size of the agent image to be displayed increases as the index indicating the certainty of the answer text increases), that is, since the agent to be referenced to (checked) is emphasized, it is possible for a user to easily know an answer of an agent that should be referenced (checked) first among a plurality of agents.

Further, according to this embodiment, it is possible to prevent the occurrence of a situation in which a screen area is used to display an answer (an answer of which the index of the certainty of the answer text is small; that is, an answer of which the degree of certainty is small) of a low reliability, and thus the answer of an agent which may possibly have an answer (an answer of which the index of the certainty of the answer text is large; that is, an answer of which the degree of certainty is large) that a user has intended is not displayed.

Further, according to this embodiment, it is possible for a user to visually recognize the certainty of the answer of the agent. As a result, it is possible for a user to easily know an answer of an agent that should be referenced (checked) first among a plurality of agents.

Further, according to this embodiment, by changing the display format of the degree of certainty of the answer of each agent, which degree of certainty cannot be represented in a single display format, in accordance with the degree of certainty of each agent, it is possible to visually present the certainty (confidence in search results) of the answer of the agent. By this configuration, a user can efficiently check search results.

Further, according to this embodiment, since the display format of the answer changes in accordance with the degree of certainty of the answer of the agent instead of displaying a monotonous answer of the agent, it is possible to give an impression to a user that “the agent is a partner having the characteristic of autonomously moving”.

Further, according to this embodiment, when another agent is selected, it is possible to implicitly detect that the presented answer was wrong (it can be used for learning data).

Further, according to this embodiment, a user pays attention to, for example, a displayed answer of an agent of which the display form has been changed so that the visibility thereof increases or the amount of information increases from among the answers of the plurality of agents, whereby it is possible to help the user determine to preferentially refer to the answer of the agent of which the display has been changed as the one having more certainty (confidence) (at least this time than that in the previous time). Alternatively, a user pays attention to a displayed answer of which the display form has been changed so that visibility thereof is reduced (or the increased visibility thereof is returned to its original level) or the amount of information is reduced (or so that the increased amount of information is returned to its original amount), whereby it is possible to help the user interpret (i.e., determine) the answer of the agent of which the display has been changed as the one having less certainty (confidence) (at least this time than that in the previous time) and determine to refer to the answers of other agents as well. In this way, it is possible to implement a system capable of further increasing the possibility of presenting all answers valuable to a user and helping to prevent the user from being subject to the inconvenience of having to check answers.

Next, a modified example will be described.

In the above-described embodiment, although a description has been given of an example in which the display form (e.g., the number of characters displayed in the answer text and the size of the agent image) of the agent is changed in accordance with an index indicating the certainty of the answer text of the agent by using the above Expressions 1 to 3, the present disclosure is not limited thereto.

In the above-described embodiment, as examples in which the display form of the agent is changed in accordance with an index indicating the certainty of the answer text of the agent, a description has been given of an example (e.g., an example in which the number of characters displayed in the answer text is increased as the index indicating the certainty of the answer text increases) in which the display form of the answer text of the agent is changed and an example (e.g., an example in which the size of the agent image is increased as the index indicating the certainty of the answer text increases) in which the display form of the agent image symbolizing the agent is changed. However, the present disclosure is not limited thereto. In the following description, another example (the modified example) in which the display form of the agent is changed in accordance with an index indicating the certainty of the answer text of the agent will be described.

### Modified Example 1 of the Display Form of the Agent

A facial expression of the agent may be changed in accordance with an index indicating the certainty of the answer text of the agent. For example, when the index indicating the certainty of the answer text is relatively large (e.g., a value greater than a threshold), an agent image of a smiling face may be used as the agent image, while when the index indicating the certainty of the answer text is relatively small (e.g., a value less than the threshold), an agent image of a sad face may be used as the agent image.

By the above, a user can know the degree of certainty (confidence) of the answer text of each agent based on the facial expression of each agent. Thus, the user can easily determine an answer of an agent that should be referenced (checked) first among a plurality of agents.

### Modified Example 2 of the Display Form of the Agent

A density (light and shade) of the agent image may be changed in accordance with the index indicating the certainty of the answer text of the agent. For example, when the index indicating the certainty of the answer text is relatively large, an agent image of which the density is relatively higher may be used as the agent image, while when the index indicating the certainty of the answer text is relatively small, an agent image of which the density is relatively lower may be used as the agent image.

By the above, a user can know the degree of certainty (confidence) of the answer text of each agent based on the density (light and shade) of the image of each agent. Thus, the user can easily determine an answer of an agent that should be referenced (checked) first among a plurality of agents.

### Modified Example 3 of the Display Form of the Agent

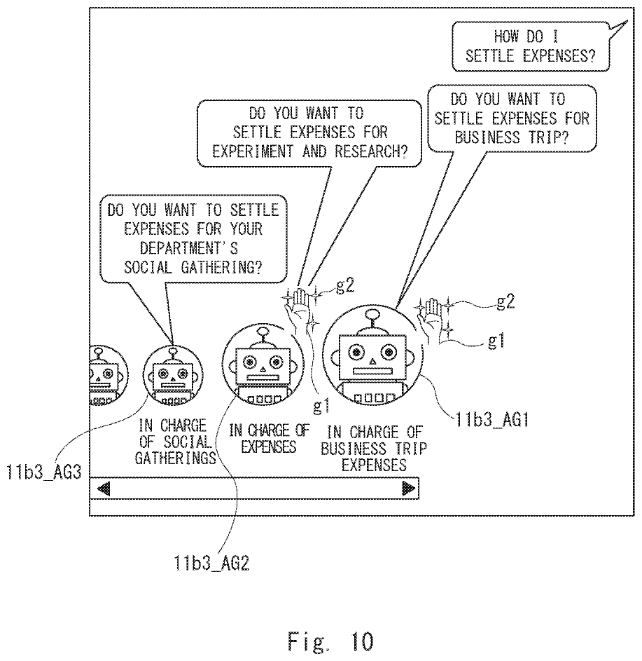

The number of additional displays (an integer of zero or greater) additionally displayed near the agent image may be changed in accordance with the index indicating the certainty of the answer text of the agent. For example, for an agent (e.g., the agents 11b3_AG1 and 11b3_AG2 in FIG. 10) of which the index indicating the certainty of the answer text is relatively large, an additional display (e.g., a raised hand (palm) image g1 and a star image g2 in FIG. 10) may be displayed near an agent image symbolizing this agent, while for an agent (e.g., the agent 11b3_AG3 in FIG. 10) of which the index indicating the certainty of the answer text is relatively small, an additional display may not be displayed.

By the above, a user can know the degree of certainty (confidence) of the answer text of each agent based on the presence or absence of the additional display (e.g., the raised hand (palm) image g1 and the star image g2 in FIG. 10) displayed near each agent. Thus, the user can easily determine an answer of an agent that should be referenced (checked) first among a plurality of agents.

In this case, the number of additional displays (e.g., the star image g2 in FIG. 10) displayed near the agent image symbolizing the agent (e.g., the agent 11b3_AG1 in FIG. 10) of which the index indicating the certainty of the answer text is relatively large may be larger than the number of additional displays (e.g., the star image g2 in FIG. 10) displayed near the agent image symbolizing the agent (e.g., the agent 11b3_AG2 in FIG. 10) of which the index indicating the certainty of the answer text is relatively small. FIG. 10 is a modified example of the screen displayed on the display unit 26.

By the above, a user can know the degree of certainty (confidence) of the answer text of each agent based on the number of additional images (e.g., the star image g2 in FIG. 10) displayed near each agent. Thus, the user can easily determine an answer of an agent that should be referenced (checked) first among a plurality of agents.

Further, in the above-described embodiment, although a description has been given of an example in which the index indicating the certainty of the answer text of the agent is a score of the answer text of each of the plurality of agents selected by the response selection unit 12c, the present disclosure is not limited thereto. For example, the index indicating the certainty of the answer text of the agent may be the probability that the answer (the answer text) matches the purpose of the user's question, information about whether or not the answer of the agent has been highly evaluated in the past, and information about whether or not it has been quoted.

In the above-described embodiment, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The numerical values shown in the above-described embodiment are all examples, and it is needless to say that any other suitable numerical values can be used.

The above-described embodiment is merely illustrative in all respects. The present disclosure is not limited by the description of the above-described embodiment. The present disclosure may be implemented in various other ways without departing from its spirit or principal features.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An agent display method for simultaneously displaying a plurality of agents each configured to respond to a speech text of a user, the agent display method comprising:
a speech text acquisition step of acquiring the speech text of the user;
an answer selection step of selecting, from a database of each of the agents storing a question text and an answer text corresponding to the question text, the answer text of each of the plurality of agents to the speech text of the user; and
an agent display step of displaying a screen including the plurality of agents,
wherein the agent display step includes changing, in accordance with an index indicating certainty of the answer text of at least one of the agents, a display form of the at least one of the agents.

2. The agent display method according to claim 1, wherein the agent display step includes changing the display form of the answer text of the agent in accordance with the index.

3. The agent display method according to claim 2, wherein the display form of the answer text to be changed is the number of characters displayed in the answer text.

4. The agent display method according to claim 1, wherein the agent display step includes changing the display form of an agent image symbolizing the agent in accordance with the index.

5. The agent display method according to claim 4, wherein the display form of the agent image to be changed is a size of the agent image.

6. The agent display method according to claim 4, wherein the display form of the agent image to be changed is a facial expression of the agent.

7. The agent display method according to claim 4, wherein the display form of the agent image to be changed is a density of the agent image.

8. The agent display method according to claim 4, wherein the display form of the agent image to be changed is an additional display that is additionally displayed near the agent image.

9. The agent display method according to claim 1, wherein the answer selection step includes selecting the answer texts of the plurality of respective agents to the speech text of the user from the database based on a degree of similarity between the speech text of the user and the question text stored in the database.

10. The agent display method according to claim 1, wherein the answer selection step includes selecting the answer texts of the plurality of respective agents to the speech text of the user from the database based on the degree of similarity between the speech text of the user and the question text stored in the database and a feature of the agent.

11. The agent display method according to claim 1, wherein the answer text of each of the plurality of agents to the speech text of the user is an overview of the answer text.

12. The agent display method according to claim 11, further comprising:
a selection receiving step of receiving the selection performed by the user with regard to the agents; and
a step of displaying a detail of the answer text of the agent selected by the user from among the agents.

13. A non-transitory computer readable medium storing a program for causing an information processing apparatus comprising at least one processor to execute:
speech text acquisition processing of acquiring a speech text of a user;
answer selection processing of selecting, from a database of each of a plurality of agents storing a question text and an answer text corresponding to the question text, the answer text of each of the plurality of agents to the speech text of the user; and
agent display processing of displaying a screen including the plurality of agents,
wherein the agent display processing includes changing, in accordance with an index indicating certainty of the answer text of at least one of the agents, a display form of the at least one of the agents.

14. An agent display system configured to simultaneously display a plurality of agents each configured to respond to a speech text of a user, the agent display system comprising:
a speech text acquisition unit configured to acquire the speech text of the user;
an answer selection unit configured to select, from a database of each of the agents storing a question text and an answer text corresponding to the question text, the answer text of each of the plurality of agents to the speech text of the user; and
an agent display unit configured to display a screen including the plurality of agents,
wherein the agent display unit changes, in accordance with an index indicating certainty of the answer text of at least one of the agents, a display form of the at least one of the agents.
